(19) United States
(12) Patent Application Publication
(10) Pub. No.: US 2008/0070182 A1
(43) Pub. Date: Mar. 20, 2008

(54) ORTHODONTIC ELEMENTS AND OTHER MEDICAL DEVICES WITH A FLUORINATED POLYMER, AND METHODS

(75) Inventors: William E. Wyllie, Pasadena, CA (US); Naiyong Jing, Woodbury, MN (US); Joan V. Brennan, Sierra Madre, CA (US); David S. Arney, St. Paul, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/533,633

(22) Filed: Sep. 20, 2006

(51) Int. Cl. A61C 3/00

(52) U.S. Cl. 433/8; 433/10

(57) ABSTRACT

A medical device, particularly an orthodontic element, that includes a surface having a polymeric film disposed thereon (e.g., a liner disposed in an archwire slot of an orthodontic bracket), wherein the film comprises a fluorinated polymer and a treated surface having an adhesive thereon.

### BACKGROUND

In orthodontic treatment, tiny devices known as brackets are secured to the patient's teeth. An archwire is received in a slot of each bracket, and is held in place in the slots by ligating wires or by small elastic O-rings that extend around each bracket and the archwire. The teeth connected to the brackets are urged toward orthodontically correct positions by bends or twists placed in the archwire, or by elastomeric modules interconnecting certain brackets. The archwire serves as a track to guide sliding movement of the brackets so that the associated teeth are shifted toward desired positions.

In the past, orthodontic brackets were often made of stainless steel, and archwires were made of stainless steel or alloys containing stainless steel, nickel, and titanium. In general, frictional resistance to sliding movement of the metal brackets, while not insignificant, is a factor that is not considered unsatisfactory by most orthodontists. However, metal brackets are not aesthetic and are sometimes referred to as a “tin grin” that may be an embarrassment to the patient.

Orthodontic brackets made of non-opaque plastic materials such as polycarbonate have been introduced by various manufacturers over the years. Unfortunately, some plastic brackets exhibit undue deformation of the archwire slots because of creep of the material as orthodontic forces are applied by the wire to the brackets. Undue deformation of the archwire slots may prevent precise control of movement of the associated teeth, and in some instances may cause the brackets to fracture. Replacement of brackets during orthodontic treatment is time consuming and is often considered a nuisance by the orthodontist as well as by the patient.

It has been proposed in the past to provide metallic archwire slot liners for plastic brackets, in part as an attempt to avoid deformation of the plastic material. Examples of archwire slot liners are described in U.S. Pat. Nos. 3,964,165, 4,299,569, and 4,302,532. Metallic archwire slot liners for plastic brackets provide sliding mechanics that resemble the sliding mechanics as would be observed when an all-metal bracket is used.

Orthodontic brackets have also been made of translucent ceramic material such as polycrystalline aluminum oxide as is described in U.S. Pat. No. 4,954,080. Ceramic is a relatively hard material in comparison to plastic and does not exhibit creep deformation in areas adjacent the archwire slot when subjected to forces of the archwire. However, application of an undue force by the archwire may fracture the bracket, possibly because of localized areas of relatively high stress concentrations. Archwire slot liners for ceramic brackets are described in U.S. Pat. No. 5,380,196.

Metal slot liners (e.g., stainless steel slot liners) provide advantage to ceramic brackets such as increased bracket strength, enhanced sliding mechanics, and retention of ceramic pieces upon fracture debonding. Fracture debonding is described in U.S. Pat. No. 5,439,379. Metal slot liners, however, are visible in the early treatment stages when narrow stainless steel wires are used. Furthermore, when used with translucent ceramic brackets, stainless steel liners impart a slight gray color to the translucent bracket body. These attributes of a metal liner may detract from the overall aesthetic qualities of the product. Although glass liners have been proposed to provide good aesthetics and low friction, the brittle nature of a glass liner would not provide retention of ceramic pieces upon fracture debonding. Thus, a need exists for slot liners for orthodontic elements, particularly orthodontic brackets, that provide good aesthetics and low friction, and retention of ceramic pieces upon fracture debonding.

### SUMMARY

The present invention is directed to a medical device, in particular dental elements such as an orthodontic element, and methods of making.

In one embodiment, there is provided an orthodontic element including: a bracket including an archwire slot in which an archwire engages; and a liner disposed in the archwire slot, wherein the liner comprises a fluorinated polymer and a treated surface having an adhesive thereon; wherein the treated surface of the liner having an adhesive thereon is in contact with the archwire slot.

In another embodiment, there is provided a medical device including: a surface of the medical device; and a polymeric film disposed on the surface of the medical device, wherein the film comprises a fluorinated polymer and a treated surface having an adhesive thereon; wherein the treated surface of the film having an adhesive thereon is in contact with the surface of the medical device.

In yet another embodiment, there is provided a method of preparing an orthodontic element. The method includes: providing an orthodontic bracket including an archwire slot in which an archwire engages; providing a liner that includes a fluorinated polymer; activating a surface of the liner to provide surface functionalization; applying an adhesive to the functionalized surface of the liner; and placing the liner having an adhesive thereon in the archwire slot.

Herein, “polymeric film” of the present invention (e.g., liner for an orthodontic bracket) refers to a film that is dimensionally stable.

The term “comprises” and variations thereof do not have a limiting meaning where these terms appear in the description and claims.

The words “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, “a,” “an,” “the,” “at least one,” and “one or more” are used interchangeably. Thus, for example, a film that comprises “a” fluoropolymer can be interpreted to mean that the film includes “one or more” fluoropolymers.

The term “and/or” means one or more or all of the listed elements.

Also herein, the recitations of numerical ranges by endpoints include all numbers subsumed within that range (e.g., 1 to 5 includes 1, 1.5, 2, 2.75, 3, 3.80, 4, 5, etc.).

As used herein, the term “room temperature” refers to a temperature of about 20° C. to about 25° C. or about 22° C. to about 25° C.

The above summary of the present invention is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE DRAWINGS

The invention will be further explained with reference to the drawings, wherein:

FIG. 1 is a perspective view of a liner for an orthodontic bracket according to a representative embodiment of the invention;

FIG. 2 is a perspective view of a bracket having the liner shown in FIG. 1; and

FIG. 3 is a perspective view of a self-ligating bracket with clips having the liner shown in FIG. 1.

### DETAILED DESCRIPTION OF ILLUSTRATIVE EMBODIMENTS

The present invention is directed to a medical device, in particular dental elements such as an orthodontic element, and methods of making. Exemplary devices include a polymeric film disposed on a surface of a medical device, wherein the film is made of a fluorinated polymer and has a treated surface having an adhesive thereon. The film's treated surface having an adhesive thereon is in contact with the surface of the medical device.

A medical device is an instrument, apparatus, implement, machine, contrivance, implant, or other similar or related article, including a component part, or accessory which is intended for use in the diagnosis of disease or other conditions, or in the cure, mitigation, treatment, or prevention of disease, in man or other animals, or is intended to affect the structure or any function of the body of man or other animals, and which does not achieve any of its primary intended purposes through chemical action and is not metabolized for the achievement of any of its primary intended purposes. Such devices include medical devices such as implants, medicament containers, denture base liners, medical tubing, stents, catheters, as well as various dental devices including ceramic brackets, non-metal brackets, metal brackets, buccal tubes, bands, metal ligature ties, clips, arch wires, headgear tubes, auxiliary tubes, Class II correctors, headgear, hand instruments, and various other tools.

In a preferred embodiment, the medical device is an orthodontic element that includes a bracket with an archwire slot in which an archwire engages; and a liner disposed in the archwire slot. The liner is a polymeric film made of a fluorinated polymer and has a treated surface having an adhesive thereon. The liner's treated surface having an adhesive thereon is in contact with the archwire slot.

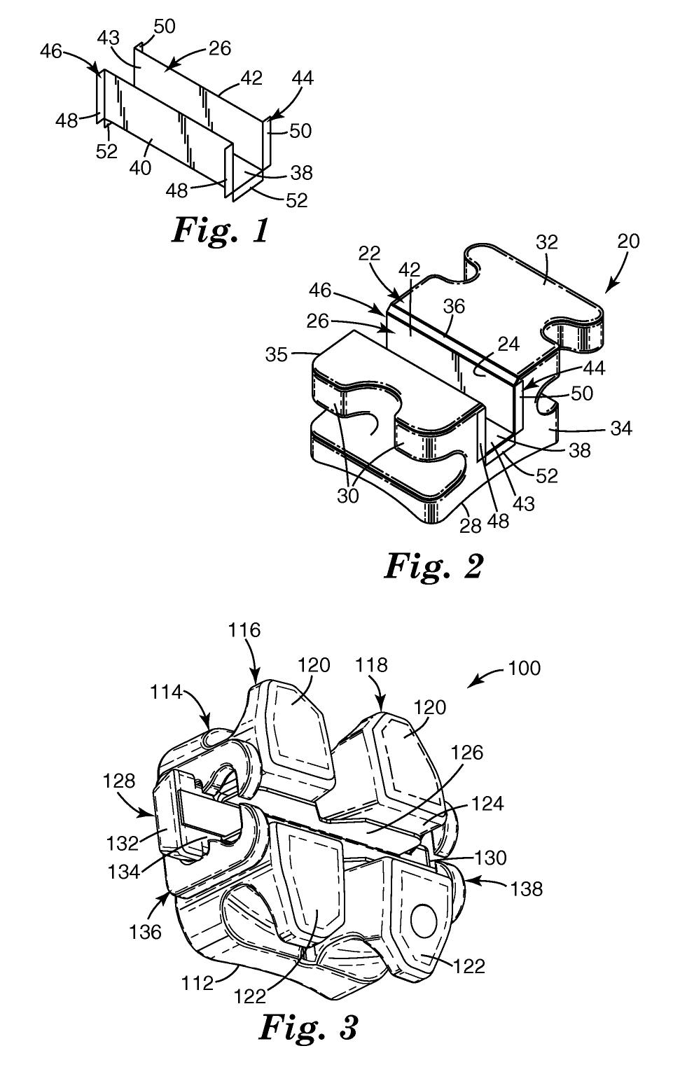

Referring to this preferred orthodontic embodiment, an orthodontic bracket 20 according to one embodiment of the present invention is illustrated in FIG. 2. The bracket 20 includes a ceramic bracket body 22 having an elongated channel 24. A liner 26 is snugly received in the channel 24 in mating fashion and is shown alone in FIG. 1.

The bracket body 22 has a base 28 with a compound contour for attaching the bracket 20 directly to a patient's tooth. A labial face of the body 22 includes a pair of spaced apart occlusal tiewings 30, 30 and a gingival hook 32 having mesial and distal notches. The channel 24 of the body 22 extends from a mesial side 34 to an opposite, distal side 35 along a central, mesial-distal axis of the body 22. A pair of opposed, chamfered wall sections 36 is located between the labial face of the body 22 and the channel 24 to facilitate insertion of an archwire into the liner 26.

The liner 26 (in FIGS. 1 and 2) includes a central portion having a bottom wall 38, an occlusal wall 40 and a gingival wall 42. The occlusal wall 40 and the gingival wall 42 are parallel to each other and extend in a direction perpendicular to the bottom wall 38. The walls 38, 40, 42 present an archwire slot 43 having a U-shaped configuration in a longitudinally transverse reference plane. The U-shaped configuration of the archwire slot 43 matches the cross-sectional shape of a rectangular archwire having similar cross-sectional dimensions, and thus is adapted to complementally receive the archwire in close-fitting relation for orthodontic treatment according to a technique known as edgewise therapy.

Referring to FIG. 2, the liner 26 includes a mesial end portion 44 and a distal end portion 46 that extend beyond the mesial side 34 and the distal side 35 respectively. As shown in FIG. 1, both of the end portions 44, 46 of the liner 26 can include an occlusal section 48 extending in an occlusal direction, a gingival section 50 extending in a gingival direction, and a lingual section 52 extending in a lingual direction. The sections 48, 50, 52, which are optional, extend in directions parallel to (and flatly contact) the respective underlying sides 34, 35. In the bracket 20 depicted in FIG. 2, the mesial and distal sides 34, 35 are perpendicular to the longitudinal axis of the archwire slot 43; hence the folded-over sections 48, 50, 52 of the liner end portions 44, 46 extend in respective, common reference planes that are substantially perpendicular to the longitudinal axis of the archwire slot 43. However, it is also possible to construct a bracket according to the invention with mesial and distal sides that extend at an angle other than ninety degrees relative to the longitudinal axis of the archwire slot, in which case the folded-over end portions of the liner would also extend at substantially the same, non-ninety degree angle. The sections 48, 50, 52 are optional and provide some additional protection of the ceramic archwire slot. Alternatively, the liner 26 may fit entirely across the archwire slot 43.

In another embodiment, the medical device is an orthodontic element that includes a bracket with an archwire slot in which an archwire engages; a liner disposed in the archwire slot; and mesial and distal clips which fit to mesial and distal protrusions extending outwardly from the bracket base, the clips releasably retaining an archwire in the archwire slot. The liner is a polymeric film made of a fluorinated polymer and has a treated surface having an adhesive thereon. The liner's treated surface having an adhesive thereon is in contact with the archwire slot and both protrusions as shown in FIG. 3.

Referring to the orthodontic embodiment of FIG. 3, an orthodontic bracket 100 according to one embodiment of the present invention is illustrated. The bracket 100 includes an elongated channel 124. A liner 126 (analogous to the liner 26 shown in FIG. 1) is snugly received in the channel 124 in mating fashion.

The appliance 100 includes a base 112 for bonding the appliance to the patient's tooth enamel by the use of an adhesive. Preferably, the base 112 has an outwardly facing concave compound contour that matches the convex compound contour of the patient's tooth surface to which it is bonded. Optionally, the base 112 is provided with grooves, particles, recesses, undercuts, a chemical bond enhancement material or any other material or structure, or any combination of the foregoing that facilitates bonding of the appliance 100 directly to the patient's tooth surface.

A body 114 extends outwardly from the base 112 in a generally buccolabial direction. The body 114 includes a mesial body portion 116 and a distal body portion 118 that is spaced from the mesial body portion 116. In this embodiment, each of the portions 116, 118 includes an occlusal tiewing 120 and a gingival tiewing 122, although one or more of the tiewings 120, 122 could be omitted if desired. Preferably, as shown in FIG. 3, the body 114 (including the body portions 116, 118) is integrally connected to the base 112, and the body 114 and the base 112 form a single, unitary component.

The appliance 100 also includes an archwire slot liner 124 that is fixed to the body portions 116, 118. The archwire slot liner 124 defines occlusal, gingival, and lingual sides of an archwire slot 126. The archwire slot 126 longitudinally extends in a generally mesial-distal direction across the appliance 100, including through a channel of the body portions 116, 118. The archwire slot liner 124 may have a mesial extension that is somewhat “T-shaped,” to match the generally T-shaped configuration presented by the neck 134 and the head 132. However, other constructions are also possible.

The appliance 100 includes a mesial post 128 and a distal post 130 that are integrally connected to the mesial body portion 116 and the distal body portion 118 respectively. The posts 128, 130 extend outwardly in opposite directions away from each other and from the body 114. Preferably, each post 128, 130 extends along a reference axis that is parallel to the longitudinal axis of the archwire slot 126. The mesial post 128 includes an outermost head 132 and a neck 134 that integrally interconnects the head 132 and the mesial body portion 116.

The appliance 100 also includes a latch for releasably retaining an archwire in the archwire slot. In the illustrated embodiment the latch includes a mesial clip 136 that is connected to the mesial post 128, and a distal clip 138 that is connected to the distal post 130.

The orthodontic bracket can be made of a polycrystalline or monocrystalline ceramic, an organic polymer (e.g., a polycarbonate, a polyacrylic), a metal, or a combination thereof (e.g., an organic/inorganic composite). For certain embodiments, the orthodontic bracket is made of a polycrystalline ceramic.

For certain embodiments, ceramic brackets can be treated with an adhesion promotion material that includes, for example, a silane, a zirconate, a titanate, or a combination thereof for promoting adhesion of overlying materials, whereas metal brackets can be treated with a silane. Examples of such treatment protocols and materials are described in International Patent Application Publication No. WO 00/69393 and U.S. Pat. No. 6,960,079.

The liner of the orthodontic element (or a polymeric film of other medical devices) is preferably at least 12.5 microns thick. The maximum thickness of the liner 26 of the orthodontic element (or a polymeric film of other medical devices) depends on the application and would typically be no more than 500 microns thick, more often no more than 250 microns thick, and even more often no more than 125 microns thick.

The material that is used to make the liner of the orthodontic element (or a polymeric film of other medical devices) includes at least one fluorinated polymer. The fluorine atoms can be in the backbone, side chains, or combinations thereof. For certain embodiments, the fluorinated polymer is perfluorinated. The fluorinated polymer can be a homopolymer or copolymer (i.e., a polymer prepared from two or more different monomers, which includes terpolymers, tetrapolymers, etc.).

The material that is used to make the liner may or may not be a blend of polymers. The fluorinated polymer blends can be either a blend of more than one fluorinated polymer (such as a blend of FEP/THV, which is fluorinated ethylene-propylene copolymer and tetrafluoroethylene-hexafluoropropylene-vinylidene fluoride terpolymer), or a blend of a fluoropolymer and a nonfluorinated polymer (such as the compatible blends of PMMA/PVDF (polymethylmethacrylate and polyvinylidene difluoride), PVDF/PEMA (polyvinylidene difluoride and polyethylmethacrylate), and polyvinylidene difluoride and polyvinyl acetate.

The fluorinated polymer can be elastomeric, thermoplastic, or thermoset. For certain embodiments, the fluorinated polymer is thermoplastic. If desired, the liner of the orthodontic element (or polymeric film of other medical devices) may include coextruded layers, which may include fluorinated or nonfluorinated polymers (e.g., a polyolefin), or adhesive materials.

For certain embodiments, the fluorinated polymer is crystalline. Preferably, the level of crystallinity is greater than 30%. This can be determined by using differential scanning calorimetry (DSC).

For certain embodiments, the fluorinated polymer has a weight average molecular weight of at least 20,000 Daltons, and for other embodiments at least 50,000 Daltons, and for still other embodiments at least 100,000 Daltons.

Examples of suitable fluorinated polymers include: a tetrafluoroethylene homopolymer (such as polytetrafluoroethylene or “PTFE”); a tetrafluoroethylene copolymer (such as ethylene-tetrafluoroethylene copolymer available under the tradename TEFZEL from E.I. DuPont de Nemours and Co., Wilmington, Del., and fluorinated ethylene-propylene copolymer or “FEP” comprised of tetrafluoroethylene and hexafluoropropylene); a hexafluoropropylene copolymer (such as a fluoroplastic terpolymer of hexafluoropropylene-tetrafluoroethylene-ethylene or “HTE” from 3M Dyneon, Oakdale, Minn.), a vinylidine fluoride homopolymer (such as polyvinylidene difluoride or “PVDF” available under the trade designation KYNAR from Boedeker Plastics, Inc., Shiner, Tex.); a vinylidine fluoride copolymer (such as a tetrafluoroethylene-hexafluoropropylene-vinylidene fluoride terpolymer or “THV” available, for example, from 3M Dyneon, and a fluoroelastomer copolymer of vinylidene fluoride and hexafluoropropylene available under the trade designation TECNOFLON from Solvay Solexis, Thorofare, N.J.); a vinyl fluoride homopolymer (such as that available under the trade designation TEDLAR from E.I. DuPont de Nemours and Co., Wilmington, Del.); a vinyl fluoride copolymer; a chlorotrifluoroethylene homopolymer (“PCTFE” such as those available under the tradenames KEL-F from 3M Co., St. Paul, Minn., and ACLAR from Honeywell, Minneapolis, Minn.); a chlorotrifluoroethylene copolymer (such as ethylene chlorotrifluoroethylene or “ECTFE” available under the tradename HALAR from Solvay Solexis, Thorofare, N.J.); a perfluorovinyl ether copolymer (such as a copolymer of tetrafluoroethylene and perfluoropropyl vinyl ether or “PFA” available from 3M Dyneon); amorphous fluoropolymers (such as a copolymer of tetrafluoroethylene-perfluoromethyl vinyl ether from 3M Dyneon, as well as those available under the tradenames TEFLON AF from E.I. DuPont de Nemours and Co., Wilmington, Del., CYTOP from Bellex International Corp., Wilmington, Del., and FLUOREL from 3M Dyneon, Oakdale, Minn.), or combinations thereof.

In certain embodiments, the fluorinated polymer is a copolymer derived from nonfluorinated monomers such as ethylene, propylene, vinylidine chloride, vinyl chloride, or combinations thereof. Examples of such polymers include propylene-tetrafluoroethylene copolymer, ethylene chlorotrifluoroethylene or “ECTFE” available under the tradename HALAR from Solvay Solexis, Thorofare, N.J., and ethylene-chlorotrifluoroethylene copolymer available under the tradename TEFZEL from E.I. DuPont de Nemours and Co., Wilmington, Del.

Fluoropolymers are desirable in this application because of their generally low coefficient of friction, generally high chemical stability, and generally high tolerance against staining. Unfortunately, however, they can be difficult to adhere to other substrates. This is overcome in the present invention through the use of an adhesive and, in certain embodiments, surface activation using various techniques, including the use of primers, to provide various surface functionalization.

Thus, for certain embodiments, at least one surface of the polymeric film (e.g., liner in an orthodontic bracket) is treated thermally (particularly for partially fluorinated materials), chemically (e.g., by laser as in laser ablation, acid-etching, sodamide treatment, corona treatment, e-beam processing, plasma etching, glow discharge, or flame treatment), or photochemically (e.g., actinic radiation such as ultraviolet radiation). Such surface modification methods are described, for example, in U.S. Pat. No. 4,743,327 (glow discharge reaction), U.S. Pat. No. 6,057,414 (ignited methane plasma), and U.S. Pat. No. 5,219,894 (thermal decomposition), JP Pat. Document 2004/107593 (ultraviolet irradiation), and U.S. Pat. No. 4,219,520 and Brennan, J. Ph.D. Thesis, “Surface Chemistry of Poly(vinylidene fluoride), 1991 (sodium/ammonia surface modifications). This treated surface preferably has an adhesive thereon and enhances the adhesion between the polymeric film and the adhesive.

For certain embodiments, at least one surface of the polymeric film (e.g., liner in an orthodontic bracket) is activated through treatment with a primer. Suitable primers are resins that are either unfilled or lightly filled (e.g., with less than 15 wt-% filler). The polymer surface may be activated through photochemical treatment with primers which include electron donor compounds such as an amine (aliphatic or aromatic), polyethyleneimine, a phosphine, phenol, thiophenol, phenolate, thiophenolate, thioether, and combinations thereof. Chemical activation of the polymer surface is also achieved through treatment with a priming solution which may include nucleophilic compounds such as a water-soluble metal sulfide, a metal hydrogen sulfide, a metal hydroxide, and combinations thereof in the presence of a phase transfer catalyst, such as a tetraalkyl or tetraaryl phosphonium or ammonium salt, a crown ether, or a combination thereof. Exemplary primers are also disclosed in U.S. Pat. Nos. 6,752,894 and 6,844,030, and in U.S. Pat. Application Publication Nos. 2003/0049455 and 2005/0080212. This primed surface preferably has an adhesive thereon and enhances the adhesion between the polymeric film and the adhesive.

For certain embodiments, at least one surface of the polymeric film (e.g., liner in an orthodontic bracket) is treated with a primer and simultaneously and/or subsequently thermally treated, photochemically treated, or both. In one embodiment, for example, a fluoropolymer surface is treated with an electron donor compound and exposed to actinic radiation, preferably, the electron donor compound is exposed to actinic radiation through the fluoropolymer.

Functionalization may also occur via grafting of one polymer onto the surface of another (e.g., the fluoropolymer-containing polymeric film). The polymer to be grafted may contain preferred functionality either in the polymer backbone or side chain. A functionalized polymer can also be formed and grafted in situ at the polymeric surface of a first polymer via reaction with a monomer containing functional groups. For example, polymer chains containing functionality may be radiation grafted onto the fluoropolymer surface, or the monomer containing the desired functionality may be radiation grafted or “grown” from the fluoropolymer surface. In addition, chemical agents such as hydroperoxide or other peroxy compounds may be used to thermally graft polymers containing the appropriate functionality or grown from the polymer surface via radical sites resulting from thermal cleavage of peroxy groups. This grafted surface preferably has an adhesive thereon and enhances the adhesion between the polymeric film and the adhesive.

In addition to the fluoropolymer surface being modified to produce desired chemical functionality for enhanced adhesion to the adhesive, for example, some physical roughening may occur to the extent that adhesion is improved via both chemical and physical modification of the polymeric surface.

Chemical functionality may be randomly integrated into the fluoropolymer surface or may be patterned. Random incorporation is preferred.

It is also preferred to modify only the outer few microns or less of the polymer surface so as to limit bulk changes in the fluoropolymer. Furthermore, it is preferred that only one side of the fluoropolymer film is modified, leaving the surface properties of the opposite surface intact, for example, translucency, stain resistance, frictional properties, and other physical properties.

Thus, a preferred surface activation process allows the treated surface side of the polymeric film to contribute to excellent adhesion to a device (e.g., orthodontic bracket) surface while maintaining desirable properties of the polymeric films, such as translucency or transparency of the polymeric film. It is believed that this occurs through the formation of chemical functionalities that chemically interact with the adhesive. This interaction may result in chemical bonding, which is most preferred, forming strong bonds between fluoropolymer and adhesive, or may involve weaker van der Waals forces, or both. Hydrogen bonding between functionality on the fluoropolymer surface (amines or hydroxyl groups, for example) and adhesive (for example, ketones or aldehydes or carboxylic acids) is another way adhesion between modified polymer surface and adhesive can be improved.

The formation of even a low percentage of polar or hydrophilic functionality on a fluoropolymer surface will result in improved wetting of the adhesive to the fluoropolymer, thereby improving adhesion. Examples of suitable functionalities include hydroxyl groups, ether groups, epoxy groups, peroxy groups (including hydroperoxy), carboxylic acid or ester groups, carbonyl groups (including ketones and aldehydes), isocyanate groups and thioisocyanate groups, mercaptan (—SH) groups, sulfide groups, sulfonic acid groups, amine groups (primary, secondary, or tertiary), imine groups, as well as carbon-carbon double and triple bonds.

For certain embodiments, preferred functionalities include carboxylic acid, carboxylic ester, sulfide, and ether functionalities. For certain embodiments, preferred functionalities include ketone, aldehyde, peroxy (including hydroperoxy), and epoxy functionalities. For certain embodiments, preferred functionalities include amines (with primary and secondary amines being more preferred over tertiary amines due to their nucleophilic character and ability to covalently bond with functional groups within adhesives such as epoxies), imines, mercaptans, hydroxyls, as well as carbon-carbon double and triple bonds. Combinations of chemical functionalities may be used for improving adhesion; however, it is preferred that higher densities of the most preferred functionalities for the particular adhesive reside at the surface. For example, it would be preferred for amines to be in greater density at the surface than ether groups when an epoxy adhesive is used.

Depending on the adhesive, different functionalities may be selected to provide desirable results. Typically, chemical groups can be characterized as nucleophilic, electrophilic, or even radical initiating. Nucleophilic groups are most preferred for adhesives such as epoxies and acrylates. Amines and mercaptans are examples of nucleophilic groups, which are desirable because they can enter into chemical reactions with chemical functionality in the adhesive layer, such as epoxies, and thereby create strong chemical bonds and promote strong adhesion between the functionalized fluoropolymer and adhesive. Surface amines can also hydrogen bond with functionality within the adhesive, for example, carboxylic acids or other carbonyl functionality, or, vice versa, carboxylic acid groups on the surface of the fluoropolymer may hydrogen bond with amines in adhesives. Hydroperoxy and peroxy compounds are examples of radical initiators, which, once heat activated, may then crosslink with many different adhesives, including acrylates.

Surface electrophilic groups (e.g., epoxies, isocyanates) are also used in polymer surface modifications of the type used to enhance adhesion between functionalized fluoropolymers and adhesives. As an example, a stable electrophilic group at the surface of the fluoropolymer could be formed from, for example, a surface hydroxyl group treated with a Lewis Acid such as titanium tetrachloride and then subsequently reacting the surface electrophilic group with a nucleophile from within the adhesive (e.g., amine or thiol). Another example is to provide the adhesive with stable electrophilic groups such as epoxy groups, for example, within an epoxy adhesive that can then be reacted with nucleophilic sites on the fluoropolymer surface (e.g., amine, thiol), thereby forming strong covalent bonds. Epoxy groups can be made more electrophilic by treating them with Lewis acids as mentioned above.

For certain embodiments, the surface of the medical device (e.g., the archwire slot) on which the polymeric film/adhesive combination is disposed is treated with a primer to further enhance adhesion. Suitable primers are resins that are either unfilled or lightly filled (e.g., with less than 15 wt-% filler). Exemplary primers are disclosed herein above, such as in U.S. Pat. Nos. 6,752,894 and 6,844,030, and in U.S. Pat. Application Publication Nos. 2003/0049455 and 2005/0080212.

For certain embodiments the treated polymeric film (e.g., liner for an orthodontic bracket) is translucent or transparent. As used herein, translucent means that the film permits light to pass through it but diffuses the light such that objects on the opposite side are not clearly visible; and transparent means that the film transmits light with little or no diffusion such that objects on the opposite side are clearly visible.

For certain embodiments, an adhesive is used to attach the polymeric film (e.g., liner for an orthodontic bracket) to a surface (e.g., the archwire slot of an orthodontic bracket). The adhesive can be chemically attached to the polymeric film such that no distinct layers are discernible or the polymeric film can include a fluorinated polymer film and a distinct layer of an adhesive disposed on the treated surface of the film.

Suitable adhesives can be of a wide variety, including pressure sensitive and hot melt adhesives. Suitable adhesives are resins that include higher filler loadings than primers (e.g., at least 60 wt-% filler). They can include an epoxy, a silicone, a (meth)acrylate, a urethane, a silicone polyurea, or combinations thereof. Examples of suitable commercially available adhesives include LOCTITE 3981 epoxy (Henkel Corp., Rocky Hill, Conn.), SCOTCH-WELD 2216A/B Epoxy Adhesive (3M Co., St. Paul, Minn.), and SCOTCH-WELD DP-460 Epoxy Adhesive (3M Co., St. Paul, Minn.).

For certain embodiments, the adhesive is translucent or transparent. For certain embodiments, the adhesive is chosen such that it is also stain resistant.

The adhesive can include various additives, including fillers to provide additional strength, crosslinkers, rheology modifiers (as described, for example, in U.S. Pat. No. 6,126,922), additives for thermal stability, and the like. They may also contain adhesion promoters such as silanes, zirconates, and titanates.

For certain embodiments, a suitable liner/adhesive combination is one that adheres to a bracket for at least 2 hours in water at 100° C. For certain embodiments, the peel strength of a suitable liner/adhesive combination to the bracket is at least 2 pounds per inch (1.9 N/cm) and preferably, at least 5 pounds per inch (4.8 N/cm), more preferably at least 10 pounds per inch (9.6 N/cm), and even more preferably at least 15 pounds per inch (14.5 N/cm).

### EXAMPLES

Objects and advantages of this invention are further illustrated by the following examples. Note however that the particular materials and amounts thereof recited in these examples, as well as other conditions and details, should not be construed to unduly limit this invention. Unless specified otherwise, all parts and percentages are by weight, all water is de-ionized water, and all molecular weights are weight average molecular weight. All chemicals and reagents were obtained from Sigma-Aldrich Corp., St. Louis, Mo.

As used herein:

“FEP” refers to a copolymer of tetrafluoroethylene and hexafluoropropylene (3M Co., St. Paul, Minn./Dyneon LLC, Oakdale, Minn.).

“THV” refers to a copolymer of tetrafluoroethylene, hexafluoropropylene, and vinylidene fluoride, available under the trade designation THV 800 from 3M Co., St. Paul, Minn./Dyneon LLC, Oakdale, Minn.

“PFA” refers to a copolymer of tetrafluoroethylene and perfluorovinylether (E.I. du Pont de Nemours and Company, Wilmington, Del.).

“PTFE” refers to polytetrafluoroethylene (3M Co., St. Paul, Minn./Dyneon LLC, Oakdale, Minn.).

“LOCTITE” refers to an epoxy adhesive commercially available under the trade designation LOCTITE 3981 from Henkel Corp., Rocky Hill, Conn.

“SCOTCH-WELD” refers to a two-part translucent epoxy adhesive available under the trade designation SCOTCH-WELD 2261 from 3M Company, St. Paul, Minn.

“SCOTCHBOND” refers to a methacrylate-based dental adhesive available under the trade designation ADPER SCOTCHBOND Multi-Purpose Adhesive from 3M Company, St. Paul, Minn.

“KEN-REACT” refers to a coupling agent available under the trade designation Ken-React KZ-TPP from Kenrich Petrochemicals Inc., Bayonne, N.J.

### Silane Treatment with glycidyloxypropyltrimethoxysilane Solution

To 37.0 g ethyl alcohol was added 0.5 g glycidyloxypropyltrimethoxysilane (SILQUEST A-187, available from GE Silicones, Danbury, Conn.), 12.45 g water, and 0.05 g glacial acetic acid to afford a primer solution. A layer of primer solution was brushed onto the alumina substrate and baked in a convection oven at 600° C. for 1 hour. After the surface was cooled to room temperature, a second layer of primer solution was brushed on followed by baking at 100° C. for another 1 hour period. The treated alumina was then removed and allowed to cool to room temperature. The primed surface of the substrate was gently rinsed with ethyl alcohol to remove any unbound silane. The primed substrate was finally allowed to dry in air and used immediately for adhesive bonding.

### Silane Treatment with 3M ESPE Rely-X Brand Ceramic Primer

Using a foam-tipped brush, a thin layer of Rely-X Ceramic Primer (available from 3M Company, St. Paul, Minn.) was applied to the surface of the alumina substrate. The substrate was then heated to 700° C. at a ramp rate of 5° C. per minute and held for 1 hour to decompose the organic components. The furnace power was then shut down and the alumina allowed to cool to room temperature. A second layer of Rely-X Ceramic Primer was then applied, baked at 100° C. for 1 hour, and allowed to cool to room temperature. The primed surface of the substrate was gently rinsed with ethyl alcohol to remove any unbound silane. The primed substrate was finally allowed to dry in air and used immediately for adhesive bonding.

### Stain Test

The ability of a fluoropolymer film sample to resist staining was determined using a standardized visual test. The following staining agents were used: freshly brewed French Roast coffee, LIPTON brand Pekoe cut black tea (one teabag steeped in one cup of hot water for 5 minutes), RAGU brand Old World Style spaghetti sauce, and FRENCH'S brand Classic Yellow mustard. Specimens were fully immersed in each staining agent within a sealed polypropylene vessel and placed in a 60° C. oven for durations of 1 day, 1 week, and 2 weeks. The degree of staining was determined visually as compared to unstained control.

### Liquid to Liquid Thermal Shock Test

Thermal cycling of bracket specimens was achieved using a Test Chamber Model No. LTSI-2-CHA (ESPEC Corporation, Grand Rapids, Mich.). Adhesive-bonded fluoropolymer test specimens were immersed in alternating fashion between two constant temperature water baths, one maintained at 5° C. and the other at 55° C. The sample was held in each bath for 30 seconds per cycle. Each specimen was subjected to 1000 cycles prior to peel strength testing.

### Peel Strength Testing

The quality of adhesion between the liner and brackets was measured using an Instrumentors Inc. SP-2000 Slip/Peel Tester (IMASS Inc., Accord, Mass.). Fluoropolymer strips 0.5 inch (1.27 cm) wide by approximately 1.25 inches (3.175 cm) length were initially bonded using a given adhesive to a substrate material. Peel strength was then obtained by peeling the strip at a 180° angle to the substrate in dynamic equilibrium at a peel speed of 6 inches (15.24 cm) per minute, with a 1 second delay and 5 second peel strength averaging time. The peel strength in pounds per inch (ppi) was determined by multiplying the time-averaged peel strength of the specimen by two. Each reported peel strength value represents an average of two to four replicated measurements.

### Classical Friction Test

Classical friction between an archwire and a bracket was determined using a custom made fixture for a QTEST/5 mechanical testing machine (MTS Systems Corporation, Eden Prairie, Minn.). The test bracket was bonded to a post connected with a 6-axis sensor, which digitally monitors the normal force applied by a ligature wire. The force required to pull the wire through the slot of the bracket at a rate of 0.1 mm perminute was measured using a 20 lb. (9.07 kg) load cell. The average kinetic frictional force, equal to the force required to pull the wire divided by two, and the average normal force were calculated for each of six nominal normal forces: 400, 600, 100, 300, 200, and 500 g (listed in order of testing). The coefficient of kinetic frictional force was determined as the slope of a linear regression line fit to a plot of average kinetic fractional force versus the average normal force.

### Examples 1-5

In Examples 1-5, photochemical modification of a fluorothermoplastic film was accomplished using a priming solution containing organic amines in an organic solvent or water. This clear priming solution was prepared by adding 2.0 g of methanol to 0.4 g polyethyleneimine solution (Product No. 40,870-0, 99% purity, Sigma-Aldrich Co., St. Louis, Mo.) and 2 drops of N,N-dimethylaniline (Product No. 515124, 99% purity, Sigma-Aldrich Co., St. Louis, Mo.). Four drops of the priming solution were placed on a 2×3 inch (5.08×7.62 cm) glass microscope slide. A 2×3 inch (5.08×7.62 cm) rectangular piece of fluoropolymer film (with a thickness ranging from 1 mil (25.4 microns) to 16 mils (406.4 microns)) was then placed on top of the slide to sandwich the solution between the film and the slide. Any air bubbles were gently pressed out to ensure that both the film and slide surfaces were fully wetted by the methanol solution. The slide, etching solution, and polymer film assembly were then placed beneath a bank of six 18-inch (45.72 cm), 15-watt germicidal ultraviolet (UV) lamps (G15T8) (General Electric Company, Fairfield, Conn.). The film assembly was placed flat with the top surface of the film spaced 1 inch (2.54 cm) from the lamps.

After UV exposure was completed, the fluoropolymer film was removed from the glass slide, thoroughly rinsed with water for 2 minutes and finally rinsed with acetone to remove residual priming solution. Films were then allowed to dry in air at ambient temperatures. The fluoropolymer was bonded within an hour after the acetone rinse. The modified fluoropolymer film was laminated against an alumina substrate (0.025 inch (635 micron) thickness, 96% purity, CoorsTek, Grand Junction, Colo.) and primed with an adhesive layer as described below. Exposure time, fluoropolymer type, fluoropolymer thickness, substrate type, and adhesive type used in preparation of Examples 1-5 are given in Table 1.

TABLE 1
Examples of ultraviolet light etched fluoropolymer bonding to substrate.

| | UV | | | | |
|---|---|---|---|---|---|
| | exposure | | | | |
| Ex- | time | Fluoro- | Film | | |
| ample | (minutes) | polymer | thickness | Substrate | Adhesive |
| 1 | 15 | FEP | 9 mil (229 | Alumina | LOCTITE |
| | | | microns) | | |
| 2 | 15 | FEP | 9 mil (229 | Alumina | LOCTITE |
| | | | microns) | | |
| 3 | 15 | FEP | 9 mil (229 | Alumina | LOCTITE |
| | | | microns) | | |
| 4 | 15 | FEP | 9 mil (229 | Alumina | SCOTCH-WELD |
| | | | microns) | | |
| 5 | 20^{(c)} | PTFE | 9 mil (229 | Alumina^{(a)} | LOCTITE^{(b)} |
| | | | microns) | | |

^{(a)}additionally primed with glycidyloxypropyltrimethoxysilane primer solution
^{(b)}contained 1 weight percent KEN-REACT coupling agent
^{(c)}etching solution rinsed from fluoropolymer film with water after 10 minutes UV exposure then fresh etching solution applied and film assembly re-exposed to UV for 10 minutes

To prepare the alumina substrate for bonding, 0.375 inch (0.953 cm) wide pieces of SCOTCH brand 1280 Circuit Plating tape (4.2 mil (107 micron), 3M Company, St. Paul, Minn.) were applied to three outside edges of the bonding surface to define a 0.75×1.5 inch (1.91×3.81 cm) rectangular bonding surface. Using a foam-tipped brush, a thin layer of epoxy adhesive was applied to the bonding surface and the surface of a 1×1.5 (2.54×3.81 cm) inch piece of fluoropolymer film. The epoxy-coated surfaces were pressed together and any visible air bubbles were gently pushed out to ensure uniform bonding. The construction was interposed between two pieces of silicone primed polyester release liner (3M Company, St. Paul, Minn.), and then again between two 2×3 inch (5.08×7.62 cm) glass slides. The entire assembly was held together firmly down the center of the substrate with one large (1 inch (2.54 cm) capacity, 2 inch (5.08 cm) width) metal binder clip (BC 100, Stock No. 99100, Office International Corp., Edison, N.J.). Curing of the epoxy was achieved by placing the assembly in a 100° C. forced air oven for 50 minutes.

Following preparation, some of the bonded fluoropolymer films were subjected to temperature cycling (see Liquid to liquid thermal shock test), others were boiled in water for 2 hours, while other films were used as is. Peel testing of the bonded films proceeded according to the experimental procedure described earlier. The failure mode, defined as the location at which separation occurred during the peel test, was also noted. Pre-test conditioning, measured peel strength, and failure mode are shown for Examples 1-5 in Table 2 below.

TABLE 2
Peel test results on Examples 1–5

| Example | Condition | Peel strength | Failure mode |
|---|---|---|---|
| 1 | As prepared | 12.7 ppi | Adhesive at |
| | | (22.2 N/cm) | fluoropolymer |
| 2 | Temperature | 0.190 ppi | Adhesive at |
| | cycled | (0.333 N/cm) | alumina |
| 3 | Boiled in water | 6.18 | Adhesive at |
| | for 2 hours | (10.8 N/cm) | alumina |
| 4 | As prepared | 9.21 | Adhesive at |
| | | (16.1 N/cm) | fluoropolymer |
| 5 | As prepared | 1.15 | Adhesive at |
| | | (2.02 N/cm) | fluoropolymer |

### Examples 6-11

Photochemical modification was conducted for Examples 6-11 using an aqueous priming solution. Here, the etching solution was prepared by adding 0.2 g of tetrabutylphosphonium bromide (Product No. 189138, 98% purity, Sigma-Aldrich Corp., St. Louis, Mo.) and 2.0 g of sodium sulfide nonanhydrate (Product No. 208043, 98% purity, Sigma-Aldrich Corp., St. Louis, Mo.) to 5.5 g of water, and stirring at room temperature for 20 minutes until a clear solution was observed. Four drops of the aqueous solution was then placed on the surface of a 2×3 inch (5.08×7.62 cm) glass microscope slide. After a 2×3 inch (5.08×7.62 cm) piece of fluoropolymer film was cleaned using an acetone-soaked laboratory wipe, it was then placed over the slide to sandwich the solution between the film and glass slide. Any air bubbles between the film and glass were gently expelled to ensure that both surfaces were fully wetted by the solution. The slide, priming solution, and polymer film assembly were then placed beneath a bank of six 18-inch (45.72 cm), 15-watt germicidal ultraviolet (UV) lamps. The film assembly was placed flat with the top surface of the film spaced 1 inch (2.54 cm) from the lamps. UV exposure time and fluoropolymer type used for Examples 6-11 are listed in Table 3.

After UV exposure was completed, the fluoropolymer film was removed from the glass slide, thoroughly rinsed with water for 2 minutes and finally rinsed with acetone for 15 seconds using an acetone squirt bottle to remove residual etching solution. Films were then allowed to dry in air at ambient temperatures for no more than 60 minutes. The substrate type and adhesives used in Examples 6-11 are likewise given in Table 3.

TABLE 3
Examples of ultraviolet light etched fluoropolymer bonding to substrate

| | Film | | | | |
|---|---|---|---|---|---|
| | exposure | | Film | | |
| Example | time | Fluoropolymer | thickness | Substrate | Adhesive |
| 6 | 20 minutes | FEP | 9 mil (229 microns) | Alumina^{(a)} | LOCTITE^{(b)} |
| 7 | 20 minutes | FEP | 9 mil (229 microns) | Alumina^{(a)} | LOCTITE^{(b)} |
| 8 | 20 minutes | FEP | 9 mil (229 microns) | Alumina^{(a)} | LOCTITE^{(b)} |
| 9 | 20 minutes | FEP | 9 mil (229 microns) | Alumina^{(d)} | SCOTCHBOND |
| 10 | 20 minutes^{(c)} | PTFE | 9 mil (229 microns) | Alumina^{(a)} | LOCTITE^{(b)} |
| 11 | 20 minutes^{(c)} | PFA | 1.8 mil (45.7 microns) | Alumina^{(a)} | LOCTITE^{(b)} |

^{(a)}additionally primed with glycidyloxypropyltrimethoxysilane primer solution
^{(b)}contained 1 weight percent KEN-REACT coupling agent
^{(c)}etching solution rinsed from fluoropolymer film with water after 10 minutes UV exposure then fresh etching solution applied and film assembly re-exposed to UV for 10 minutes
^{(d)}silane-treated using 3M ESPE Rely-X brand ceramic primer (3M Co., St. Paul, MN)

All samples were bonded to alumina substrates. To accomplish this, a 1.5×1.5 inch (3.81×3.81 cm) square bonding surface was defined by applying 0.375 inch (0.953 cm) wide pieces of 1280 Circuit Plating tape to three outside edges of the substrate. Using a foam tipped brush and under yellow safety lights a thin layer of the given adhesive was then applied to the bonding surface, along with the surface of a 1×1.5 inch (2.54×3.81 cm) rectangular piece of fluoropolymer film. The two adhesive-coated surfaces were pressed together and any visible air bubbles forced out to ensure uniform bonding. This construction was interposed between two silicone primed polyester release liners, and then again between two 2×3 inch (5.08×7.62 cm) glass slides. The entire construction was finally clamped together firmly down the middle with one large metal binder clip.

Examples 6, 7, 8, 10, and 11 used a LOCTITE epoxy adhesive for bonding. Curing of the epoxy was achieved by placing the assembly in a 100° C. forced air oven for 50 minutes. Example 9 used SCOTCHBOND adhesive for bonding. In this case, curing was achieved by irradiating the adhesive using a 3M ESPE ELIPAR brand 2500 Halogen Curing Light (3M Company, St. Paul, Minn.) for 60 seconds. The metal binder clip was removed and then the assembly further cured by twice passing it through a Fusion UV Systems UV processor (VPS-6 power supply, EPIQ 6000 irradiator, Fusion UV Systems Corp., Rockville, Md.) equipped with a Fusion D bulb operating at 600 watts per inch (236 W/cm) at a line speed of 20 feet (6.10 m) per minute. The cured assembly was finally post-baked at 100° C. in a forced air oven for 25 minutes.

After preparation, some film assemblies were subjected to temperature cycling according to the Liquid to liquid thermal shock test, others were boiled in water for 2 hours, while other films were used as is. Peel testing of the bonded films proceeded according to the experimental procedure described earlier. The failure mode, defined as the location at which separation occurred during the peel test, was also noted. The pre-test condition, peel strength, and failure mode are shown for Examples 6-11 in Table 4 below.

TABLE 4
Peel test results on Examples 6–11

| Example | Condition | Peel strength | Failure mode |
|---|---|---|---|
| 6 | As prepared | >17.1^{(a)} ppi | Adhesive at |
| | | (>30.0 N/cm) | fluoropolymer |
| 7 | Temperature | Exceeded film | N/A |
| | cycled | strength | |
| 8 | Boiled in water | 7.57 ppi | Cohesive |
| | for 2 hours | (13.3 N/cm) | |
| 9 | As prepared | 2.53 ppi | Adhesive at |
| | | (4.43 N/cm) | fluoropolymer |
| 10 | As prepared | 2.50 ppi | Adhesive at |
| | | (4.38 N/cm) | fluoropolymer |
| 11 | As prepared | 2.78 ppi | Adhesive at |
| | | (4.87 N/cm) | fluoropolymer |

^{(a)}fluoropolymer film tore in some cases; adhesion exceeded strength of the film

### Examples 12-21

In Examples 12-21, samples underwent a thermochemical surface modification process as follows. To prepare the etching solution, 1.0 g tetrabutylphosphonium bromide (Product No. 189138, 98% purity, Sigma-Aldrich Corp., St. Louis, Mo.), 3.0 g sodium sulfide nonahydrate (Product No. 203043, 98% purity, Sigma-Aldrich Corp., St. Louis, Mo.), and 3.0 g potassium hydroxide (Product No. 221473, 85% purity, Sigma-Aldrich Corp., St. Louis, Mo.) were added to 60 mL of water in a screw cap glass jar, and the solution stirred vigorously at ambient temperature for 20 minutes. The capped solution was then placed in an oven and heated to 65° C. A 2×3 inch (5.08×7.62 cm) piece of THV film, 5 mils (127 microns) or 16 mils (406 microns) in thickness, was cleaned using an acetone-soaked laboratory wipe and then submerged in the etching solution for a prescribed period of time, ranging from 30 seconds to 5 minutes. The now treated film was removed and allowed to dry in air.

Both alumina and stainless steel substrates (0.375 inch (0.953 cm) thick 17-4 stainless steel bar stock, available from McMaster-Carr Co., Chicago, Ill. USA) and cut into 1.5 inch (3.81 cm) square pieces and polished before use) were used to prepare bonded samples. To prepare the substrate for bonding, 0.375 inch (0.953 cm) wide pieces of 1280 Circuit Plating tape were applied to three outside edges of the bonding surface. Using a foam-tipped brush, a thin layer of the adhesive was applied to the bonding surface as well as the surface of a 1×1.5 inch (2.54×3.81 cm) piece of fluoropolymer film. The adhesive-coated surfaces were pressed together and any visible air bubbles were gently pushed out to ensure uniform bonding. The construction was interposed between two pieces of silicone primed polyester release liner, and then again between two 2×3 inch (5.08×7.62 cm) glass slides. The entire assembly was held together firmly down the center of the substrate with one large metal binder clip. Fluoropolymer type, film exposure time, film thickness, substrate type, and adhesive are given in Table 5 below.

TABLE 5
Examples of thermally etched fluoropolymer bonding to substrate.

| | | Film | | | |
|---|---|---|---|---|---|
| | | exposure | | | |
| Example | Fluoropolymer | time | Film thickness | Substrate | Adhesive |
| 12 | THV | 5 minutes | 9 mil | Alumina^{(a)} | LOCTITE^{(b)} |
| | | | (229 microns) | | |
| 13 | THV | 5 minutes | 9 mil (229 | Alumina^{(a)} | LOCTITE^{(b)} |
| | | | microns) | | |
| 14 | THV | 5 minutes | 9 mil (229 | Alumina^{(a)} | LOCTITE^{(b)} |
| | | | microns) | | |
| 15 | THV | 5 minutes | 9 mil (229 | Alumina^{(a)} | LOCTITE^{(b)} |
| | | | microns) | | |
| 16 | THV | 5 minutes | 9 mil (229 | Alumina^{(a)} | LOCTITE^{(b)} |
| | | | microns) | | |
| 17 | THV | 5 minutes | 9 mil (229 | Alumina^{(a)} | LOCTITE^{(b)} |
| | | | microns) | | |
| 18 | THV | 1 minute | 9 mil (229 | Alumina^{(a)} | LOCTITE^{(b)} |
| | | | microns) | | |
| 19 | THV | 5 minutes | 9 mil (229 | Stainless | LOCTITE^{(b)} |
| | | | microns) | steel | |
| 20 | THV | 5 minutes | 9 mil (229 | Alumina^{(c)} | SCOTCHBOND |
| | | | microns) | | |
| 21 | THV | 5 minutes | 5 mil (127 | Alumina^{(a)} | LOCTITE^{(b)} |
| | | | microns) | | |

^{(a)}additionally primed with glycidyloxypropyltrimethoxysilane primer solution
^{(b)}contained 1 weight percent KEN-REACT coupling agent
^{(c)}silane-treated using 3M ESPE Rely-X brand ceramic primer

In Examples 12-19 and 21, an epoxy adhesive was used. In these cases, curing took place by placing the assembly in a 100° C. forced air oven for 50 minutes. In example 20, SCOTCHBOND adhesive was used and curing of the adhesive was achieved by irradiating the adhesive using a 3M ESPE ELIPAR brand 2500 Halogen Curing Light (3M Company, St. Paul, Minn.) for 60 seconds. The metal binder clip was removed and then the assembly further cured by twice passing it through a Fusion UV Systems UV processor (VPS-6 power supply, EPIQ 6000 irradiator, Fusion UV Systems Corp., Rockville, Md.) equipped with a Fusion D bulb operating at 600 watts per inch (236 W/cm) at a line speed of 20 feet (6.10 m) per minute. The cured assembly was finally post-baked at 100° C. in a forced air oven for 25 minutes.

Some bonded fluoropolymer films were then subjected to temperature cycling according to the Liquid-to-liquid thermal shock test, others were boiled in water for 2 hours, while other films were used as is. Peel testing of the bonded films proceeded according to the experimental procedure described earlier. The failure mode, defined as the location at which separation occurred during the peel test, was also noted. The pre-test condition, peel strength, and failure mode are shown for Examples 12-21 in Table 6 below.

TABLE 6
Peel test results on Examples 12–21

| Example | Condition | Peel strength | Failure mode |
|---|---|---|---|
| 12 | As prepared | 12.2^{(a)} ppi | Adhesive at |
| | | (21.31 N/cm) | fluoropolymer |
| 13 | Temperature | 12.8^{(a)} ppi | Cohesive |
| | cycled | (22.5 N/cm) | |
| 14 | Boiled in water | 13.1^{(a)} ppi | Cohesive |
| | for 2 hours | (22.98 N/cm) | |
| 15 | As prepared | Exceeded film | N/A |
| | | strength | |
| 16 | Temperature | Exceeded film | N/A |
| | cycled | strength | |
| 17 | Boiled in water | Exceeded film | N/A |
| | for 2 hours | strength | |
| 18 | As prepared | Exceeded film | N/A |
| | | strength | |
| 19 | As prepared | Exceeded film | N/A |
| | | strength | |
| 20 | As prepared | 8.67 ppi | Adhesive at |
| | | (15.2 N/cm) | fluoropolymer |
| 21 | As prepared | Exceeded film | N/A |
| | | strength | |

^{(a)}THV 800 film tore in some cases; adhesion exceeded strength of the film

### Comparative Examples 1-9

In Comparative Examples 1-9, fluoropolymer films were bonded to both alumina and stainless steel substrates, but without prior photochemical or thermochemical surface modification.

As in previous examples, the substrate was prepared for bonding by applying 0.375 inch (0.953 cm) wide pieces of SCOTCH brand 1280 Circuit Plating tape to three outside edges of the bonding surface to define a 1.5 inch (3.81 cm) square area. Using a foam-tipped brush, a thin layer of the adhesive was applied to the bonding surface and the surface of a 1×1.5 inch (2.54×3.81 cm) piece of fluoropolymer film. The adhesive-coated surfaces were pressed together and any visible air bubbles were gently pushed out to ensure uniform bonding. The construction was interposed between two pieces of silicone primed polyester release liner, and then again between two 2×3 inch (5.08×7.62 cm) glass slides. The entire assembly was held together firmly down the center of the substrate with one large metal binder clip. Fluoropolymer type, film exposure time, film thickness, substrate type, and adhesive are given in Table 7 below.

TABLE 7
Comparative Examples of untreated fluoropolymer bonding to substrate

| Com- | | | | |
|---|---|---|---|---|
| parative | | Film | | |
| example | Fluoropolymer | thickness | Substrate | Adhesive |
| 1 | FEP | 9 mil | Alumina^{(a)} | LOCTITE |
| | | (229 microns) | | |
| 2 | FEP | 9 mil | Alumina | SCOTCH-WELD |
| | | (229 microns) | | |
| 3 | PTFE | 9 mil | Alumina^{(a)} | LOCTITE |
| | | (229 microns) | | |
| 4 | PFA | 1.8 mil | Alumina^{(a)} | LOCTITE |
| | | (46 microns) | | |
| 5 | ETFE | 5 mil | Alumina^{(a)} | LOCTITE |
| | | (127 microns) | | |
| 6 | THV | 9 mil | Alumina^{(a)} | LOCTITE |
| | | (229 microns) | | |
| 7 | THV | 5 mil | Alumina^{(a)} | LOCTITE |
| | | (127 microns) | | |
| 8 | THV | 9 mil | Alumina^{(b)} | SCOTCHBOND |
| | | (229 microns) | | |
| 9 | THV | 9 mil | Stainless | LOCTITE |
| | | (229 microns) | steel | |

^{(a)}additionally primed with glycidyloxypropyltrimethoxysilane primer solution
^{(b)}silane-treated with 3M ESPE Rely-X brand ceramic primer

In Comparative Examples 1-7 and 9, an epoxy adhesive was used. In these cases, curing was achieved by placing the assembly in a 100° C. forced air oven for 50 minutes. In comparative example 8, a SCOTCHBOND methacrylate-based adhesive was used for bonding. This adhesive was cured by irradiating the adhesive using a 3M ESPE ELIPAR brand 2500 Halogen Curing Light for 60 seconds. The metal binder clip was removed and then the assembly further cured by twice passing it through a Fusion UV Systems UV processor equipped with a Fusion D bulb operating at 600 watts per inch (236 W/cm) at a line speed of 20 feet (6.10 m) per minute. The cured assembly was finally post-baked at 100° C. in a forced air oven for 25 minutes.

All bonded fluoropolymer films were used as is. Peel testing of the bonded films proceeded according to the experimental procedure described earlier. The failure mode, defined as the location at which separation occurred during the peel test, was also noted. Pre-test condition, peel strength, and failure mode are shown for Comparative Examples 1-9 in Table 8 below.

TABLE 8
Peel test results on Comparative Examples 1–9

| Comparative | | | |
|---|---|---|---|
| Example | Condition | Peel strength | Failure mode |
| 1 | As prepared | No measureable adhesion | Adhesive at |
| | | | fluoropolymer |
| 2 | As prepared | No measureable adhesion | Adhesive at |
| | | | fluoropolymer |
| 3 | As prepared | No measureable adhesion | Adhesive at |
| | | | fluoropolymer |
| 4 | As prepared | No measureable adhesion | Adhesive at |
| | | | fluoropolymer |
| 5 | As prepared | No measureable adhesion | Adhesive at |
| | | | fluoropolymer |
| 6 | As prepared | >14.9^{(a)} ppi | Adhesive at |
| | | (>26.0 N/cm) | fluoropolymer |
| 7 | As prepared | >11.7^{(a)} ppi | Adhesive at |
| | | (>20.4 N/cm) | fluoropolymer |
| 8 | As prepared | No measureable adhesion | Adhesive at |
| | | | fluoropolymer |
| 9 | As prepared | 12.3 ppi | Adhesive at |
| | | (21.6 N/cm) | fluoropolymer |

^{(a)}fluoropolymer film stretched and tore in some cases; adhesion exceeded strength of the film

Together, the peel strength test results for Examples 1-21 (Tables 2, 4, and 6) and Comparative Examples 1-9 (Table 8) demonstrate the advantages of chemical functionalization of thermoplastic films in improving adhesion to ceramic substrates. Chemical functionalization especially improved the peel strength for FEP, PTFE, and PFA, where before functionalization, no measurable adhesion was observed. For THV 500 and 800, functionalization improved the adhesion over the non-functionalized films to the point where peel strength exceeded the thermoplastic tear strength.

### Examples 22-23

Polycrystalline alumina orthodontic brackets having a 0.030 (0.076 cm) inch width archwire slot (3M Unitek, Monrovia, Calif.) were arranged on a glass microscope slide having SCOTCH 137P Double Sided Tape on the top surface such that the bracket archwire slots were aligned. A 0.25 inch (0.635 cm) wide strip of the photochemically functionalized FEP film was cut and a thin layer of the epoxy thermoset adhesive (either LOCTITE or SCOTCH-WELD) applied to the functionalized FEP surface with a foam-tipped brush. The FEP film was wrapped around a ceramic mandrel with the epoxy adhesive side exposed and pressed into the archwire slots of orthodontic brackets. The mandrel was then fixed in place with Aluminum Foil Tape 425 (3M Company, St. Paul, Minn.) to hold the epoxy coated FEP in contact with the bracket archwire slot surface. The assembly was heated to 125° C. for 35 minutes to fully cure the epoxy adhesive. The aluminum tape was removed and the excess FEP film trimmed with a razor blade against the ceramic mandrel. The mandrel was then removed and the individual brackets separated using a small pair of scissors.

Examples 22 and 23 were prepared using the fluoropolymer types and bracket types indicated in Table 9 below. Both samples were evaluated using the classical friction test described earlier, and the coefficients of kinetic friction and r² values also listed in Table 9.

TABLE 9
Examples of fluoropolymer films bonded to brackets

| | | | Coefficient of | |
|---|---|---|---|---|
| Example | Fluoropolymer | Bracket type | kinetic friction | r² value |
| 22 | FEP | Alumina lower left cuspid bracket | 0.17 | 0.8 |
| | | (experimental, obtained from 3M | | |
| | | Unitek, Monrovia, CA) | | |
| 23 | FEP | Alumina upper left cuspid bracket | 0.19 | 0.92 |
| | | (experimental, obtained from 3M | | |
| | | Unitek, Monrovia, CA) | | |

### Comparative Examples 10-13

For comparison to Examples 22 and 23, Comparative Examples 10-13 were prepared with no fluoropolymer film disposed in the archwire slot. Bracket type are indicated in Table 10 below. All samples were evaluated using the classical friction test described earlier, and the coefficients of kinetic friction and r² values also listed in Table 10.

TABLE 10
Comparative Examples of unbonded brackets

| Com- | | | |
|---|---|---|---|
| parative | | Coefficient of | r² |
| Example | Bracket type | kinetic friction | value |
| 10 | Alumina upper bicuspid bracket | 0.19 | 0.92 |
| | (CLARITY ROTH, 3M Unitek) | | |
| 11 | Stainless steel upper bicuspid bracket | 0.19 | 0.88 |
| | (VICTORY SERIES MBT, | | |
| | 3M Unitek) | | |
| 12 | Alumina upper bicuspid bracket | 0.27 | 0.87 |
| | (TRANSCEND 2000 ROTH, 3M | | |
| | Unitek, Monrovia, CA) | | |
| 13 | Alumina upper right cuspid | 0.22 | 0.86 |
| | (Experimental, obtained from 3M | | |
| | Unitek, Monrovia, CA) | | |

The measured coefficients of kinetic friction for all FEP-bonded brackets were at, or below, those of non-bonded control brackets. This result suggests that the sliding mechanics, as described by classical friction measurements, should also be similar to or better than common orthodontic brackets.

### Examples 24

In Example 24, 8 polycrystalline alumina orthodontic brackets having a 0.030 inch (0.076 cm) width archwire slot were arranged on a glass microscope slide having SCOTCH 137P Double Sided Tape on the top surface such that the bracket archwire slots were aligned. A 0.25 inch (0.635 cm) wide strip of the photochemically functionalized FEP film was cut and a thin layer of LOCTITE epoxy thermoset adhesive applied to the functionalized FEP surface with a foam-tipped brush. The FEP film was wrapped around a ceramic mandrel with the epoxy adhesive side exposed and pressed into the archwire slots of orthodontic brackets. The mandrel was then fixed in place with Aluminum Foil Tape 425 to hold the epoxy coated FEP in contact with the bracket archwire slot surface. The assembly was heated to 125° C. for 35 minutes to fully cure the epoxy adhesive. The aluminum tape was removed and the excess FEP film trimmed with a razor blade against the ceramic mandrel. The mandrel was then removed and the individual brackets separated using a small pair of scissors.

Bonded brackets were then subjected to a stain test according to the procedure described earlier. In this test, bonded brackets were exposed to four staining agents—coffee, tea, tomato sauce, and mustard—and visually compared with unstained control samples. A sample size of 2 brackets was used for each condition. These tests produced minor staining in coffee, tea, and tomato sauce, and moderate staining with mustard. In all cases, the staining was confined to the regions of excess adhesive and not in the FEP liner itself.

The complete disclosures of the patents, patent documents, and publications cited herein are incorporated by reference in their entirety as if each were individually incorporated. Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

What is claimed is:

1. An orthodontic element comprising:
a bracket comprising an archwire slot in which an archwire engages; and
a liner disposed in the archwire slot, wherein the liner comprises a fluorinated polymer and a treated surface having an adhesive thereon;
wherein the treated surface of the liner having an adhesive thereon is in contact with the archwire slot.

2. The element of claim 1 wherein fluorinated polymer comprises a blend of polymers.

3. The element of claim 1 wherein the fluorinated polymer comprises fluorine in the backbone, side chains, or combinations thereof.

4. The element of claim 1 wherein the fluorinated polymer is thermoplastic.

5. The element of claim 1 wherein the fluorinated polymer is perfluorinated.

6. The element of claim 1 wherein the fluorinated polymer is crystalline.

7. The element of claim 1 wherein the fluorinated polymer has a weight average molecular weight of at least 20,000 Daltons.

8. The element of claim 1 wherein the fluorinated polymer comprises a tetrafluoroethylene homopolymer or copolymer, a hexafluoropropylene copolymer, a vinylidine fluoride homopolymer or copolymer, a vinyl fluoride homopolymer or copolymer, a chlorotrifluoroethylene homopolymer or copolymer, a perfluorovinyl ether copolymer, an amorphous fluoropolymer, or combinations thereof.

9. The element of claim 1 wherein the fluorinated polymer is a copolymer of nonfluorinated monomers comprising ethylene, propylene, vinylidine chloride, vinyl chloride, or combinations thereof.

10. The element of claim 1 wherein the treated surface of the liner comprises functionalities selected from the group consisting of hydroxyl groups, ether groups, epoxy groups, peroxy groups, carboxylic acid groups, carboxylic ester groups, carbonyl groups, isocyanate groups and thioisocyanate groups, mercaptan groups, sulfide groups, sulfonic acid groups, amine groups, imine groups, carbon-carbon double bonds, carbon-carbon triple bonds, and combinations thereof.

11. The element of claim 1 wherein the treated surface of the liner is treated thermally, chemically, or photochemically.

12. The element of claim 1 wherein the treated surface of the liner is treated with a primer.

13. The element of claim 1 wherein the archwire slot is primed.

14. The element of claim 1 wherein the treated surface of the liner comprises a functionalized polymer grafted onto a fluorinated polymer film.

15. The element of claim 1 wherein the treated liner is translucent or transparent.

16. The element of claim 1 wherein the adhesive comprises a pressure sensitive adhesive or a hot melt adhesive.

17. The element of claim 1 wherein the adhesive comprises an epoxy, a silicone, a (meth)acrylate, a urethane, a silicone polyurea, or combinations thereof.

18. The element of claim 1 wherein the liner comprises a fluorinated polymer film and a treated surface having a layer of an adhesive thereon.

19. The element of claim 1 wherein the bracket comprises a polycrystalline ceramic, an organic polymer, a metal, or a combination thereof.

20. The element of claim 1 wherein the liner is at least 12.5 microns thick.

21. The element of claim 1 wherein the liner adheres to the bracket for at least 2 hours in water at 100° C.

22. The element of claim 1 wherein the peel strength of the liner and adhesive to the bracket is at least 1.9 N/cm.

23. A medical device comprising:
a surface of the medical device; and
a polymeric film disposed on the surface of the medical device, wherein the film comprises a fluorinated polymer and a treated surface having an adhesive thereon;
wherein the treated surface of the film having an adhesive thereon is in contact with the surface of the medical device.

24. A method of preparing an orthodontic element, the method comprising:
providing an orthodontic bracket comprising an archwire slot in which an archwire engages;
providing a liner comprising a fluorinated polymer;
activating a surface of the liner to provide surface functionalization;
applying an adhesive to the functionalized surface of the liner; and
placing the liner having an adhesive thereon in the archwire slot.

25. The method of claim 24 further comprising priming the archwire slot prior to contacting it with the liner and adhesive.

26. The method of claim 24 wherein activating the surface of the liner comprises treating the surface of the liner with a primer.

27. The method of claim 26 wherein activating the surface of the liner further comprises treating the surface photochemically.

28. The method of claim 26 wherein activating the surface of the liner further comprises treating the surface thermally.

29. The method of claim 24 wherein activating the surface of the liner comprises treating the surface thermally, chemically, or photochemically.

30. The method of claim 26 wherein the adhesive comprises an epoxy, a silicone, a (meth)acrylate, a urethane, a silicone polyurea, or combinations thereof.
